(19) United States
(12) Patent Application Publication
(10) Pub. No.: US 2007/0153219 A1
(43) Pub. Date: Jul. 5, 2007

(54) Apparatus and method for cutting liquid crystal display device and method for fabricating liquid crystal display device using the same

(75) Inventor: Jung Sik Kim, Buyeo-Gun (KR)

Correspondence Address: MCKENNA LONG & ALDRIDGE LLP, 1900 K STREET, NW, WASHINGTON, DC, 20006, US

(73) Assignee: LG.PHILIPS LCD CO., LTD., Yongdungpo-Gu (KR)

(21) Appl. No.: 11/477,797

(22) Filed: Jun. 30, 2006

(30) Foreign Application Priority Data
Dec. 29, 2005 (KR) 10-2005-134601

(51) Int. Cl. G02F 1/13

(52) U.S. Cl. 349/187

(57) ABSTRACT

A cutting apparatus includes a cutting unit for forming a preliminary scribing line extending a predetermined distance from an end portion of a substrate; and a laser cutter for expanding the substrate by irradiating a laser beam onto the substrate and contracting the expanded substrate so as to cut the substrate. The laser cutter may include a laser to heat-expand the substrate and a cooling unit to contract the substrate by cooling the heat-expanded substrate.

This application claims the benefit of Korean Patent Application No. 10-2005-134601, filed on Dec. 29, 2005, which is hereby incorporated by reference for all purposes as if fully set forth herein. This application incorporates by reference co-pending application, Ser. No. 10/184,096, filed on Jun. 28, 2002 entitled “SYSTEM AND METHOD FOR MANUFACTURING LIQUID CRYSTAL DISPLAY DEVICES FROM LARGE MOTHER SUBSTRATE PANELS” (Attorney Docket Number 8733.666.00); and co-pending application, Ser. No. _______, filed on Jun. 29, 2006, entitled “METHODS OF MANUFACTURING LIQUID CRYSTAL DISPLAY DEVICES” (Attorney Docket Number 8733.1713.00) for all purposes as if fully set forth herein.

### BACKGROUND OF THE INVENTION

1. Field of the Invention

The present invention relates to an apparatus and method for cutting a liquid crystal display device, and particularly, to an apparatus and method for cutting a liquid crystal display device using a laser which is capable of preventing a generation of glass chips and a defection of cut surfaces by cutting a liquid crystal display device using a laser.

2. Discussion of the Related Art

A Liquid Crystal Display (LCD) device is a type of display device for displaying images by supplying a data signal according to image information to individual liquid crystal cells arranged in a matrix to control the optical transmissivity of each liquid crystal cell.

A typical LCD device includes an LCD panel in which the liquid crystal cells are arranged in a matrix form and a driver integrated circuit (IC) for driving the liquid crystal cells in the LCD panel.

The LCD panel includes a color filter substrate and a thin film transistor array substrate facing each other and a liquid crystal layer disposed between the color filter substrate and the thin film transistor array substrate. The driver integrated circuit includes a gate driver integrated circuit and a data driver integrated circuit.

On the thin film transistor array substrate of the LCD panel, a plurality of data lines for transmitting data signals supplied from a data driver integrated circuit to the liquid crystal cells are arranged perpendicular to a plurality of gate lines for transmitting scan signals supplied from a gate driver integrated circuit to the liquid crystal cells. The liquid crystal cells are arranged in regions defined by crossings of the data lines and the gate lines.

The gate driver integrated circuit supplies the scan signals to the plurality of gate lines sequentially so that the liquid crystal cells arranged in a matrix can be sequentially selected one line by one line. The data signals are supplied to the liquid crystal cells of the selected line from the data driver integrated circuit through a plurality of data lines.

A common electrode and a pixel electrode are respectively formed at the inner sides of the color filter substrate and the thin film transistor array substrate to thereby applying an electric field to the liquid crystal layer. The pixel electrode is formed correspondingly to each liquid crystal cell formed on the thin film transistor array substrate, while the common electrode is integrally formed on an entire surface of the color filter substrate. Accordingly, light-transmittance of the liquid crystal cells can be individually controlled by controlling a voltage applied to the pixel electrode while a voltage is applied to the common electrode.

A thin film transistor used as a switching device is formed at the respective liquid crystal cells to control the voltage applied to the pixel electrode formed on each liquid crystal cell.

Meanwhile, the plurality of thin film transistor array substrates are formed on a large mother substrate and the plurality of color filter substrates are formed on another mother substrate. Then, the two mother substrates are bonded, so that a plurality of LCD panels is formed at the same time to improve yield. Herein, a process for cutting the bonded substrates into unit LCD panels is required.

Typically, the cutting process of the unit LCD panels includes forming a scribing line at a surface of the mother substrate by a diamond wheel having hardness greater than that of glass, and breaking the substrate by applying a mechanical force thereto. Hereinafter, an LCD panel of the related art will be described with reference to the attached drawings.

FIG. 1 is a plan view showing a schematic planar structure of a unit LCD panel of the related art prepared by bonding together a thin film transistor array substrate and a color filter substrate of the LCD device.

Referring to FIG. 1, an LCD panel 10 comprises an image display unit 13 having liquid crystal cells arranged in a matrix form, a gate pad unit 14 connected to gate lines of the image display unit 13, and a data pad unit 15 connected to data lines. The gate pad unit 14 and the data pad unit 15 are formed on edge areas of a thin film transistor array substrate 1 that do not overlap the color filter substrate 2. The gate pad unit 14 provides the gate lines of the image display unit 13 with each corresponding scan signal supplied from a gate driver integrated circuit, and the data pad unit 15 provides the data lines with image information supplied from a data driver integrated circuit.

On the thin film transistor array substrate 1 of the image display unit 13, the data lines are arranged to perpendicularly cross the gate lines. A thin film transistor is formed at each crossing of a data line and a gate to switch the liquid crystal cells. Pixel electrodes are connected to the thin film transistors to drive the liquid crystal cells. A passivation layer is formed on the entire surface of the thin film transistor array substrate 1 to protect the electrodes and the thin film transistors.

Color filters separated by a black matrix for each cell area are formed on the color filter substrate 2 of the pixel display unit 13. A transparent common electrode is formed on the thin film transistor array substrate 1.

The thin film transistor array substrate 1 and the color filter substrate 2 are bonded to each other with a cell gap maintained between the substrates 1 and 2. The substrates 1 and 2 are bonded together by means of sealant formed at the peripheral regions of the image display unit 13. A liquid crystal layer (not shown) is formed in the space between the thin film transistor array substrate 1 and the color filter substrate 2.

FIG. 2 is a view showing a cross-sectional structure of a first mother substrate having thin film transistor array substrates 1 and a second mother substrate having color filter substrates 2, wherein the first and second mother substrates are bonded to each other to form a plurality of LCD panels.

Referring to FIG. 2, the thin film transistor array substrate 1 of each unit LCD panel is longer than the color filter substrate 2, because as illustrated in FIG. 1, the gate pad unit 14 and the data pad unit 15 are formed at the edges of the thin film transistor array substrate 1 which do not overlap the color filter substrate 2.

Hence, the second mother substrate 30 and the color filter substrates 2 formed thereon are spaced apart from each other by a dummy region 31 corresponding to the width of each thin film transistor array substrate 1 protruding beyond the first mother substrate 20.

Moreover, the unit LCD panels are arranged to maximize the use of the first and second mother substrates 20 and 30. Although the arrangement varies with the models of the unit LCD panels, the unit LCD panels are typically spaced apart from each other at a distance corresponding to the area of another dummy region 32.

After the first mother substrate 20 having the thin film transistor array substrates 1 is bonded to the second mother substrate 30 having the color filter substrates 2, a scribing process and a breaking process are carried out to separate the individually LCD panels.

A related art cutting process for separating the unit liquid crystal display panels will be explained with reference to FIG. 3.

FIG. 3 is a view illustrating a structure of a related art cutting apparatus used in the breaking process.

Referring to FIG. 3, a related art apparatus for cutting a liquid crystal display panel may include a table 42, first and second mother substrates 20 and 30 loaded on the table 42 after completing the bonding and liquid crystal layer forming processes, and a cutting wheel 51 for processing the first and second mother substrates 20 and 30 and thus forming scribing lines thereon.

In the related art apparatus for cutting the liquid crystal display panel, when the bonded first and second mother substrates 20 and 30 including a plurality of liquid crystal display panels, the cutting wheel 51 positioned over the first and second mother substrates 20 and 30 moves downwardly and rotates while applying a particular pressure to the second mother substrate 30 to thus form a groove-shaped scribing line at the surface of the second mother substrate 30.

Such scribing lines are also formed on the first mother substrate 20. That is, the cutting wheel 51 is used to process the first mother substrate 20 to form the scribing lines at the positions corresponding to the positions of the subscribing lines 58 formed on the second mother substrate 30. Accordingly, in the related art apparatus for cutting the liquid crystal display panel, the first and second mother substrates 20 and 30 are separately processed to form the scribing lines thereon. The second mother substrate 30 is first processed using the cutting wheel 51 and thereafter the first mother substrate 20 is laid upwardly by turning the liquid crystal display panel over to process the first mother substrate 20 using the cutting wheel 51.

After forming the scribing lines on both the first and second mother substrates 20 and 30, the first and second mother substrates 20 and 30) are pressed to divide the first and second mother substrates 20 and 30 along the scribing lines.

However, the following problems may occur when using the related art apparatus for cutting the liquid crystal display panel as.

First, a substrate defect may occur. The cutting method using the cutting wheel involves the application of a mechanical force to a substrate with the cutting wheel. When processing a substrate by pressing the cutting wheel on the mother substrate, the depths of the scribing lines may vary according to a pressure generated between the cutting wheel and the substrate. The varied depths of the scribing lines may result in portions of the substrate not being separated when applying the pressure to separate the unit LCD panels and portions of the substrate may be destroyed or taken away.

Secondly, foreign materials may be generated. When processing the substrate with the cutting wheel, foreign materials such as glass chips may be generated. The generated foreign materials may cause defects in processes in processing lines in a factory.

### SUMMARY OF THE INVENTION

Accordingly, the present invention is directed to an apparatus and method for cutting liquid crystal display device and method for fabricating liquid crystal display device using the same that substantially obviates one or more of the problems due to limitations and disadvantages of the related art.

An advantage of the present invention is to provide an apparatus and method for cutting a substrate using a laser capable of preventing a generation of a defective substrate by cutting the substrate with a laser.

Another advantage of the present invention is to provide an apparatus and method for cutting a substrate using a laser which is capable of preventing a substrate from being destroyed or cut randomly cut into by cutting the substrate by irradiating a laser beam after forming a preliminary scribing line having a certain distance from an end portion of the substrate.

Another advantage of the present invention is to provide a method for fabricating a liquid crystal display device using the substrate cutting apparatus using the laser.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, a substrate cutting apparatus includes a cutting unit to form a preliminary scribing line extending a predetermined distance from an end portion of a substrate; and a laser cutter to irradiate a laser beam unto a substrate to expand the substrate and to contract the expanded substrate so as to cut the substrate.

In another aspect of the present invention, a substrate cutting method includes forming a preliminary scribing line having a certain distance from an end portion of a substrate toward the center of the substrate, and separating the substrate by irradiating a laser beam onto the substrate.

In another aspect of the present invention, a method for fabricating a liquid crystal display device includes: providing a first and a second substrate; providing thin-film transistor driving circuits on the first substrate; providing a color filter layer on the second substrate; loading one of the first and second substrates; forming a preliminary scribing line extending a certain distance from an end portion of the loaded substrate toward the center of the substrate; cutting the substrate by irradiating a laser beam onto the substrate; and bonding the cut substrate to a second cut substrate to form a liquid crystal display panel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a plan view showing a structure of a typical LCD panel;

FIG. 2 is a sectional view showing a substrate on which a plurality of LCD panels are formed;

FIG. 3 is a view showing a related art LCD panel cutting apparatus;

FIGS. 4A through 4C are views showing a substrate cut by use of a substrate cutting apparatus in accordance with a first embodiment of the present invention;

FIGS. 5A through 5C are views showing a substrate cut by use of a substrate cutting apparatus in accordance with a first embodiment of the present invention; and

FIG. 6 is a view showing an expansion of a substrate by irradiating a laser beam.

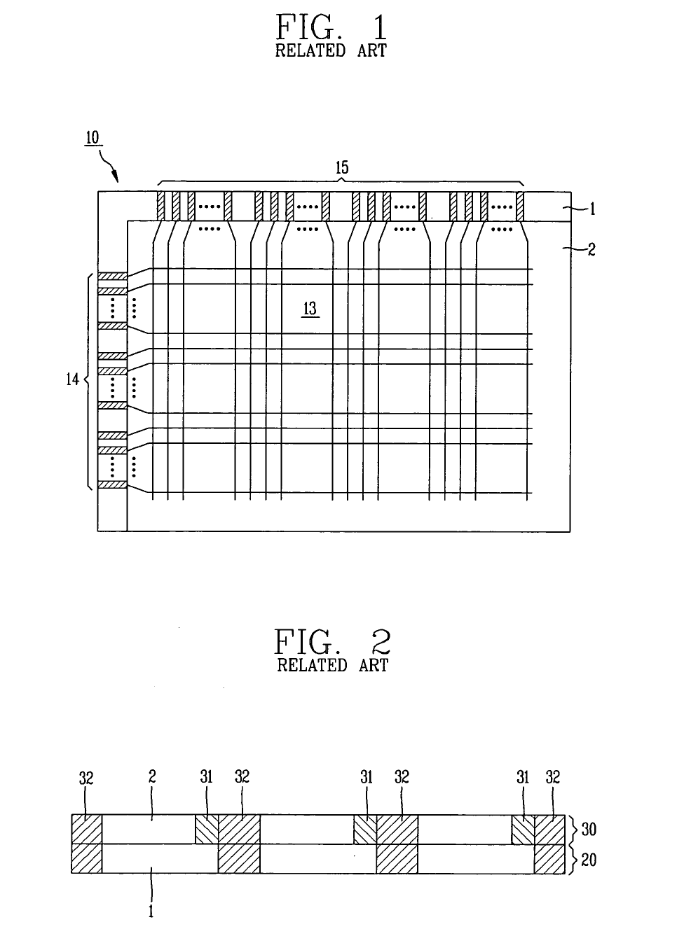

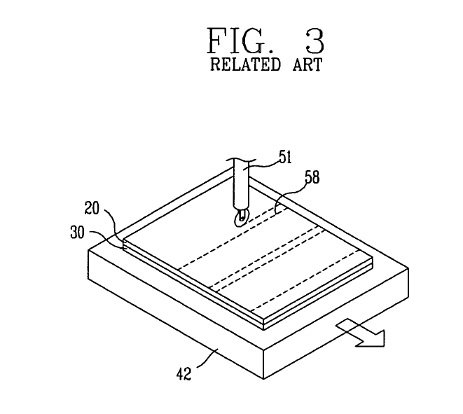

### DETAILED DESCRIPTION OF THE ILLUSTRATED EMBODIMENTS

Reference will now be given in detail to an embodiment of the present invention, examples of which are illustrated in the accompanying drawings.

A laser outputs a beam having a uniform intensity allowing the uniform application of uniform heat to a substrate on demand. The laser beam may be adjusted to illuminate a spot having desired sizes. Accordingly, heat can be applied to the desired portions of the substrate to thus cut the substrate.

The cutting apparatus may be used not only to cut a driving device array substrate with a driving device array or a color filter substrate with a color filter but also to cut an LCD panel formed by bonding the driving device array substrate and the color filter substrate. Hereinafter, regarding the explanation for the cutting apparatus using the laser, an object to be cut denotes a substrate. However, the substrate may refer to an LCD panel as well as a driving device array substrate or a color filter substrate.

An apparatus and method for cutting an LCD device using a laser in accordance with embodiments of the present invention will be described with reference to the attached drawings.

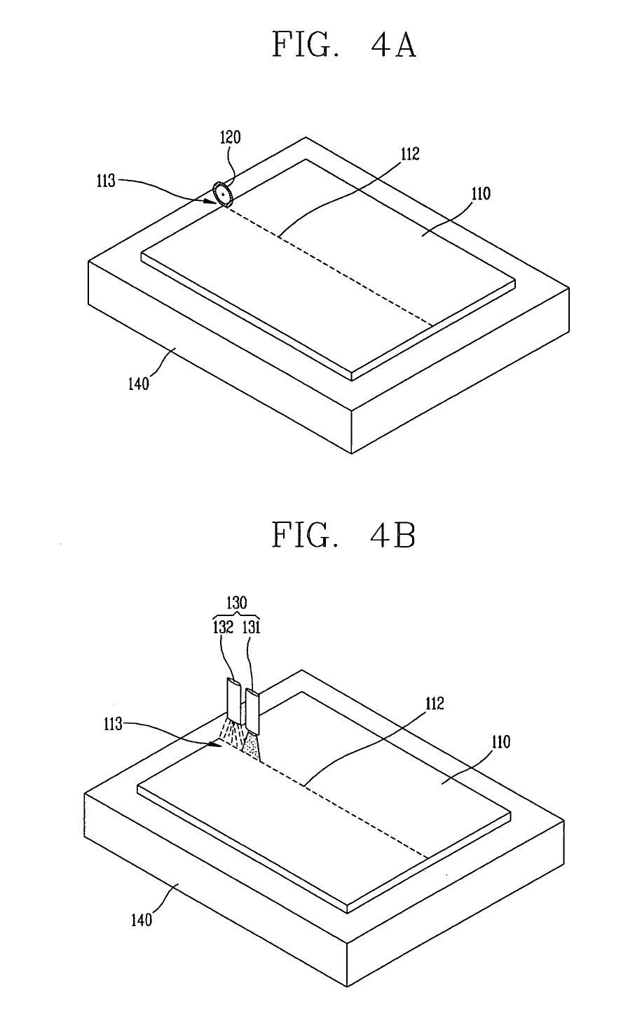

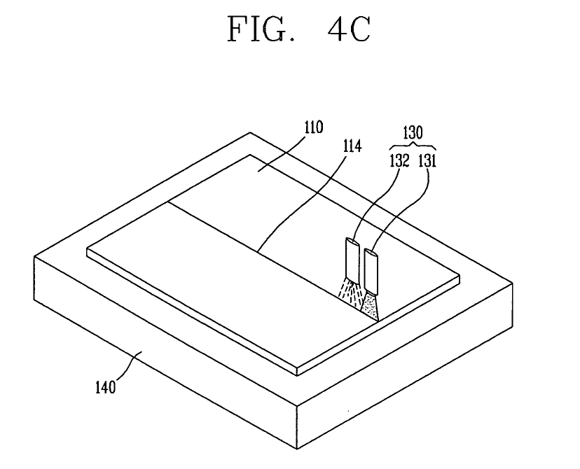

FIGS. 4A through 4C are views of cutting an LCD device using a cutting apparatus by use of a laser in accordance with a first embodiment of the present invention.

First, as shown in FIG. 4A, upon loading a substrate 110 on a table 140, a cutting wheel 120 rotates while in contact with an end portion of the substrate 110 to form a crack 113 at the end portion of the substrate 110. The reason for forming the crack 113 at the end portion of the substrate 110 will be understood as follows.

Upon irradiating of the substrate 110 with a laser beam, the substrate 110 begins to expand from heat generated by the laser beam. The end portion of the substrate 110, however, may fail to be heat-expanded by the irradiation of the laser beam, resulting in not forming a scribing line by the irradiation of the laser beam at the end portion of the substrate 110. When separating (cutting) the substrate 110 after irradiation by the laser, the end portion may be irregularly cut because of the failure to form a scribing line in the end portion. As a result, the end portion of the substrate 110 may be damaged or irregularly cut. In order to prevent such damage, a crack is formed at the end portion of the substrate 110 before irradiating the laser beam onto the substrate 110.

In the drawings, a cutting wheel 120 is used to form the crack 113 at the end portion of the substrate 110, but a yttrium aluminum garnet (YAG) laser may be used to melt the end portion of the substrate to form the crack 113.

As shown in FIG. 4B, the laser cutter 130 is brought above a virtual scribing line 112 identifying a position for a scribing line on the substrate 110 and then irradiates a laser beam on the substrate 110 at the position of the virtual scribing line. The laser cutter 130 includes a laser 131 for irradiating the laser beam onto the substrate 110 to heat-expand the substrate 110, and a cooling unit 132 for cooling the heat-expanded substrate 110 to contract the substrate. Various types of lasers may be used as the laser 131, including a carbon dioxide (CO2) laser.

The cooling unit 132 spreads cold air or liquid onto the substrate 110 to thus cool and contract the substrate 110 that has been heat-expanded by the laser 131. Alternatively, a cold foam-type fluid can be spread onto the substrate 110 in lieu of the cold air or liquid to improve cooling efficiency.

Then, as shown in FIG. 4C, while the laser cutter 130 is moved along the virtual scribing line 112, the substrate 110 is repeatedly heat-expanded and contracted. A scribing line 114 cutting into the substrate 110 is accordingly formed on the substrate 110 along the movement path of the laser cutter 130.

As described above, the substrate 110 cut by the cutting apparatus may be the driving device array substrate with the driving device array such as the thin film transistor or the color filter substrate with the color filter. Therefore, cut surfaces of each cut (separated) substrate 110 may be polished in a polishing process. Each of the separated substrates 110 is sent to a cell process to be bonded and a liquid crystal layer is formed between the bonded substrates 110, thereby obtaining an LCD device.

As a method for forming the liquid crystal layer either a dispensing method a vacuum injecting method or a more recently developed dispensing method may be used, In the vacuum injecting method liquid crystal is injected into the bonded LCD panels using a pressure difference generated in a vacuum. In the dispensing method, liquid crystal is dispensed onto a driving device array substrate or color filter substrate and then the two substrates are bonded to each other to distribute the liquid crystal on the entire substrate. In the dispensing method, the liquid crystal is dispensed onto mother substrates having a plurality of LCD panels thereon to be then bonded to each other, and thus the cutting operation using the laser cutting apparatus is applied to the bonded substrate, namely, the LCD panel. The laser cutting apparatus can be used not only to cut individual driving device array substrates or color filter substrates but can be applied to cut the LCD panels. For cutting the LCD panel, the cutting is performed by reversing the driving device array substrate and the color filter substrate, respectively, the two substrates having been bonded to each other. Thus, for cutting the LCD panel, the LCD device is completely formed by polishing the cut surfaces of the cut substrate in the polishing process and then performing an examination process.

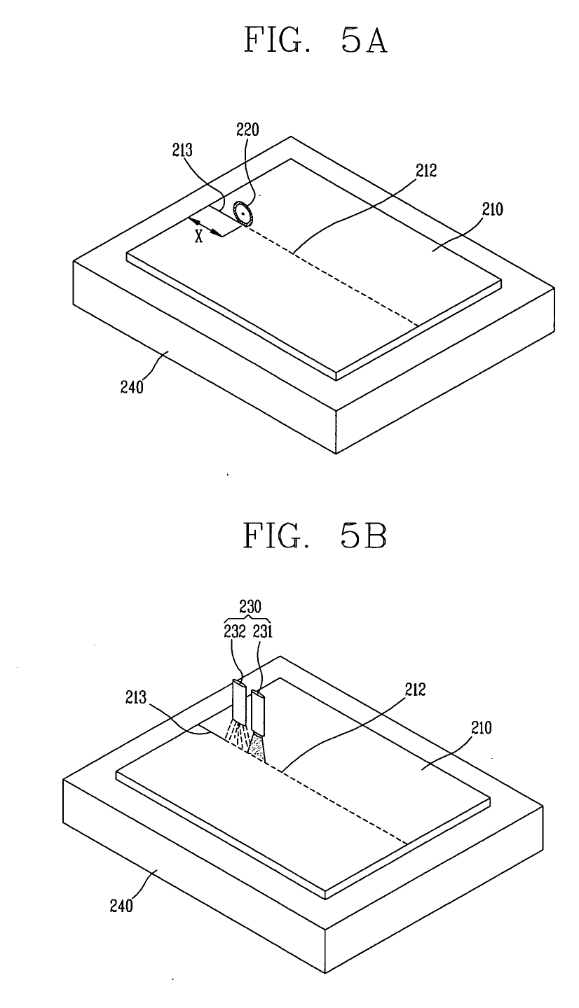

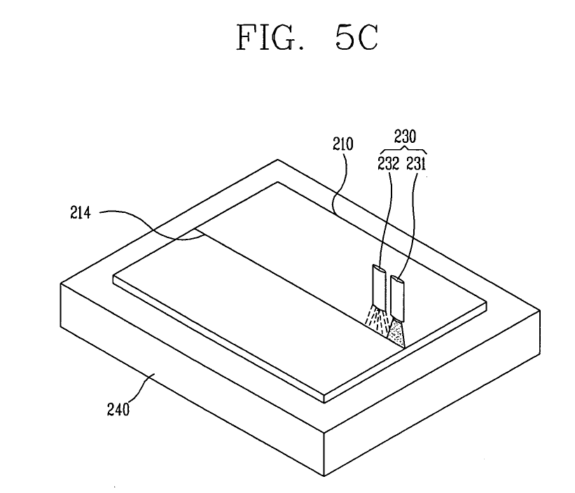

FIGS. 5A through 5C are views showing a substrate cutting method using a laser cutting apparatus in accordance with a second embodiment of the present invention.

First, as shown in FIG. 5A, upon loading a substrate 210 on a table 240, a cutting wheel 220 rotates while in contact with an end portion of the substrate 210 to thus form a preliminary scribing line 213 extending a certain distance from the end portion of the substrate 210. Compared to the embodiment of FIG. 4A in which a crack is formed only at the end portion of the substrate, the preliminary scribing line 213 extending a certain distance x from the end portion is formed in this embodiment for reasons explained as follows.

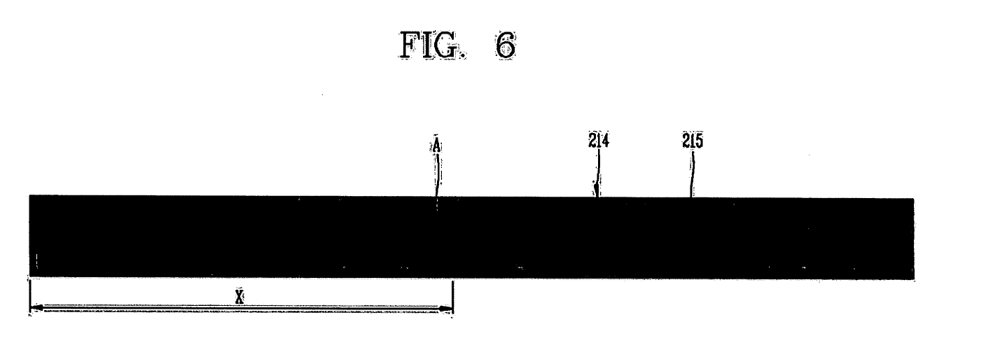

When heat-expanding the substrate 210 by irradiating the laser beam onto the substrate 210, the non-heat-expanded regions may include not only the end portion of the substrate 210 but also a region corresponding to a certain interval (distance x) extending from the end portion of the substrate 210 toward the center of the substrate 210). FIG. 6 illustrates the heat-expansion of the substrate 210 resulting from heating by irradiating the laser beam. As shown in FIG. 6, an expansion region 215 formed along the scribing line 214 ends at a distance x from the end portion of the substrate 210. That is at distance x from the end of the substrate 110 is a region not heat-expanded by the irradiation of the laser beam. Hence, forming a crack by processing only the end portion of the substrate 210 using a cutting wheel or the like, may result in the destroying the substrate 210 or cut it irregularly into the substrate at regions which are not heat-expanded.

In order to prevent the above-described problem, in the embodiment of the present invention illustrated in FIG. 5A, a preliminary scribing line 213 extending from an edge of the substrate 210 is formed having a length at least as long as distance x using the cutting wheel 220. Here, a YAG laser may be used instead of the cutting wheel 220 to melt the substrate for the corresponding distance x.

Afterwards, as shown in FIG. 5B, a laser cutter 230 including the laser 231 and a cooling unit 232 is positioned above a virtual scribing line 212 which is spaced from the end portion of the substrate 210 by the distance x. A laser beam is irradiated along the virtual scribing line 212 to heat-expand the corresponding region. A foam-type fluid or other cooling medium is spread onto the heat-expanded region by the cooling unit 232 to thusly contract the region.

As shown in FIG. 5C, as the laser cutter 230 is moved along the virtual scribing line 212, the substrate 210 is repeatedly heat-expanded and contracted. A scribing line 214 is accordingly formed on the substrate 210 along the movement path of the laser cutter 230, and the substrate 210 is cut into and separated along the scribing line.

As aforementioned, the cut (separated) substrates 210 are transferred to the polishing process to polish cut surfaces thereof. The cut surfaces polished substrates 210 are transferred to the cell process to be bonded (when cutting the driving device array substrate or the color filter substrate), or an examination process is further performed (when cutting the LCD panel), thereby obtaining the LCD device.

As described above, the present invention advantageously provides effects by cutting the substrate using the laser as follows.

First, the substrate is cut uniformly, resulting in non-generation of defect. The laser beam irradiated onto the substrate always has constant energy, and thus the substrate can be uniformly cut, thereby preventing the generation of the defective substrate.

Second, foreign materials such as glass chips may not be generated when cutting the substrate. The cutting of the substrate using the laser is implemented by the heat-expansion and contraction of the substrate, and thus the generation of glass chips by a mechanical friction or the like may be avoided.

Third, the substrate can be prevented from being damaged or cut into irregularly. The present invention can be implemented such that the end portion of the substrate is partially cut by the cutting wheel or the laser and then a laser beam is irradiated onto the substrate so as to completely cut the substrate using the heat-expansion and contraction of the substrate, whereby it is possible to prevent the end portion of the substrate from being damaged or cut into irregularly.

The illustrated embodiments include an apparatus and method for cutting a substrate by applying heat onto a substrate using a laser. Other means of applying heat for cutting the substrate by virtue of the heat-expansion and the cooling contraction of the substrate using heat sources other than a laser may alternatively be used.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A cutting apparatus comprising:
a cutting unit to form a preliminary scribing line extending a predetermined distance from an end portion of a substrate; and
a laser cutter to irradiate a laser beam unto a substrate to expand the substrate and to contract the expanded substrate so as to cut the substrate.

2. The apparatus of claim 1, wherein the cutting unit includes a cutting wheel.

3. The apparatus of claim 1, wherein the cutting unit includes a yttrium aluminum garnet (YAG) laser.

4. The apparatus of claim 1, wherein the laser cutter includes:
a laser to irradiate the substrate to heat-expand the substrate; and
a cooling unit to cool the heat-expanded substrate to contract the substrate.

5. The apparatus of claim 4, wherein the laser is a carbon dioxide (CO₂) laser.

6. The apparatus of claim 4, wherein the cooling unit is arranged to dispense a foam-type fluid.

7. The apparatus of claim 4, wherein the cooling unit is arranged to dispense a cold liquid.

8. The apparatus of claim 4, wherein the cooling unit is arranged to dispense cold air.

9. The apparatus of claim 1, wherein the laser cutter is arranged to discharge a laser beam to irradiate a substrate along a virtual scribing line extending from the preliminary scribing line formed by the cutting unit.

10. A cutting apparatus comprising:
a cutting unit to form a preliminary scribing line extending a certain distance from an end portion of a substrate; and
a unit to separate a substrate by expanding and contracting the substrate along a virtual scribing line from the preliminary scribing line.

11. A substrate cutting method comprising:
forming a preliminary scribing line extending a certain distance from an end portion of a substrate toward the center of the substrate; and
separating the substrate by irradiating a laser beam onto the substrate.

12. The method of claim 11, wherein the forming of the preliminary scribing line includes forming the preliminary scribing line extending the certain distance from the end portion using a cutting wheel.

13. The method of claim 11, wherein the forming of the preliminary scribing line includes forming the preliminary scribing line extending the certain distance from the end portion using a yttrium aluminum garnet (YAG) laser.

14. The method of claim 11, wherein the separating of the substrate includes:
expanding the substrate by irradiating the laser beam along a virtual scribing line from the preliminary scribing line; and
cooling the substrate to contraction.

15. The method of claim 14, wherein the irradiating of the laser beam includes irradiating the laser beam using a carbon dioxide (CO₂) laser.

16. The method of claim 14, wherein the cooling of the substrate includes cooling the substrate using a foam-type fluid.

17. A method for fabricating a liquid crystal display device comprising:
providing a first and a second substrate;
providing thin-film transistor driving circuits on the first substrate;
providing a color filter layer on the second substrate;
loading one of the first and second substrates;
forming a preliminary scribing line extending a certain distance from an end portion of the loaded substrate toward the center of the substrate;
cutting the substrate by irradiating a laser beam onto the substrate; and
bonding the cut substrate to a second cut substrate to form a liquid crystal display panel.

18. A method for fabricating a liquid crystal display device comprising:
dispensing a liquid crystal onto one of a driving device array substrate or a color filter substrate;
bonding the driving device array substrate and the color filter substrate to form at least one unit liquid crystal display panel;
loading the bonded substrate;
forming a preliminary scribing line extending a certain distance from an end portion of the bonded substrate toward the center of the substrate; and
irradiating a laser beam onto the substrate to separate the substrate into unit liquid crystal display panels.
